(19) United States
(12) Patent Application Publication
(10) Pub. No.: US 2024/0249214 A1
(43) Pub. Date: Jul. 25, 2024

(54) OPTIMIZING HYBRID WORKFORCES FOR EFFICIENT TASK COMPLETION

(71) Applicant: INTERNATIONAL BUSINESS MACHINES CORPORATION, ARMONK, NY (US)

(72) Inventors: Tushar Agrawal, West Fargo, ND (US); Su Liu, Austin, TX (US); Jeremy R. Fox, Georgetown, TX (US); Sarbajit K. Rakshit, Kolkata (IN); Atul Mene, Morrisville, NC (US)

(21) Appl. No.: 18/156,460

(22) Filed: Jan. 19, 2023

(51) Int. Cl. G06Q 10/0631

(52) U.S. Cl. CPC G06Q 10/063112

(57) ABSTRACT

A computer-implemented method, a computer system and a computer program product optimize a hybrid workforce to complete tasks in an environment. The method includes identifying a task to be completed by the hybrid workforce in the environment, where the hybrid workforce includes both humans and robots. The method also includes classifying the task according to suitability for human completion or robot completion. The method further includes obtaining a profile for each worker in the hybrid workforce and determining a capability of each human and each robot to perform the task from the profile. In addition, the method includes associating the task with a robot having the highest capability when the task is suitable for robot completion. Lastly, the method includes displaying an assignment of the task on a device associated with the environment, where the assignment includes a classification of the task and an association with the hybrid workforce.

### BACKGROUND

Embodiments relate generally to the field of task management in an industrial environment and, more specifically, to optimizing a hybrid human and robotic workforce to complete identified tasks in the most efficient manner.

In many industrial environments, such as a factory shop floor, a wide variety of tasks may be performed by a hybrid workforce that may include both human and robotic workers. These tasks may require a variety of skills, for instance some tasks may require human analytical skills or perhaps sheer strength that may be most efficiently provided by a machine. In addition, a specific sequencing of individual activities within a task may need to be performed. In such environments, the hybrid workforce that is present may be optimized to complete required tasks in the most efficient manner through task analysis and allocation.

### SUMMARY

An embodiment is directed to a computer-implemented method for optimizing a hybrid workforce to complete tasks in an industrial environment. The method may include identifying a task to be completed by the hybrid workforce in the environment, wherein the hybrid workforce includes a plurality of human workers and a plurality of robotic workers. The method may also include classifying the task based on whether the task is suitable for being completed by a human or by a robot. The method may further include obtaining a profile for each human worker in the plurality of human workers and for each robotic worker in the plurality of robotic workers. In addition, the method may include determining a capability to perform the task to be completed by the hybrid workforce for each human worker and for each robotic worker from the profile. The method may also include associating the task with a robotic worker in the plurality of robotic workers, wherein the robotic worker has a highest capability when the task is suitable for being completed by the robot. Lastly, the method may include displaying an assignment of the task to be completed by the hybrid workforce on a device associated with the environment, wherein the assignment includes a classification of the task and an association with the hybrid workforce.

In another embodiment, the method may include transmitting an instruction set to the robotic worker associated with the task to be completed by the hybrid workforce.

In a further embodiment, the method may include associating the task with a human worker in the plurality of human workers, wherein the human worker has the highest capability when the task is suitable for being completed by the human and transmitting a notification to a second device associated with the human worker.

In yet another embodiment, the method may include capturing task data from the environment, wherein the task data is selected from a group consisting of video data and audio data and identifying the task to be completed by the hybrid workforce in the task data.

In an additional embodiment, the method may include creating a digital twin instance for each robot worker in the plurality of robot workers and for each human worker in the plurality of human workers. In this embodiment, the method may also include simulating the task using the digital twin instance and updating the capability to perform the task to be completed by the hybrid workforce based on a digital twin simulation output.

In another embodiment, the method may include monitoring user interactions with the assignment of the task to be completed by the hybrid workforce and updating the classification of the task and the association with the hybrid workforce based on the user interactions.

In a further embodiment, a machine learning model that predicts suitability of a worker to a specific task from profile information about the worker may be used to classify an identified task.

In addition to a computer-implemented method, additional embodiments are directed to a computer system and a computer program product for optimizing a hybrid workforce to complete tasks in an industrial environment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process that optimizes a hybrid workforce to complete tasks in an industrial environment according to an embodiment.

### DETAILED DESCRIPTION

In a typical industrial environment, a hybrid workforce, i.e., one consisting of both human workers and robotic workers, comes together to complete tasks that may be assigned to the environment or identified by existing workloads. For instance, a factory shop floor may produce a specific product and individual steps may be identified in making the product, which may be learned and assigned to specific workers, taking into account capabilities of workforce members. Another example may be a warehouse environment, where packages or other items may be routinely placed in rows and vehicles such as forklifts may be driven around the warehouse or humans may carry items. The individual tasks may be identified and analyzed, including breaking tasks into individual activities, and a plan may be determined that could allow the hybrid workforce to complete the task more efficiently.

As described herein, the term “robotic worker” may refer to a multi-functional, multitask autonomous entity that may be programmed to perform a task according to an instruction set that may be passed to the robotic entity. Such an entity may be in the form of a human, where the machine may act like a human, or may be a vehicle or other machine that functions according to the instruction and is programmed to perform a task. A robotic worker may be a single entity that performs a task or may consist of multiple pieces of hardware that may work together in concert to perform the task. No specific form of robot is required in the context described herein, only that the robotic worker is distinguished from a human worker in the environment.

Current systems may determine the most efficient manner for robotic workers to complete tasks that may be performed by humans and refine the ability of the robotic workers to efficiently complete a task. However, because current industrial environments also include human workers, it may be useful to consider this hybrid workforce and take both human and robotic workers into account. Such a system or method may use digital twin simulations and historical data on the interactions between human and robotic workers with different skills to determine the most effective combination of human and robotic workers for an activity. The system or method may also consider factors such as the availability of human workers and the capabilities of robotic workers, as well as analyze organizational, or environmental in this context, costs to determine the most effective combination of humans and robots based on productivity, training costs, or maintenance costs. It should be noted that there are further factors that may be involved in the analysis that are not listed here.

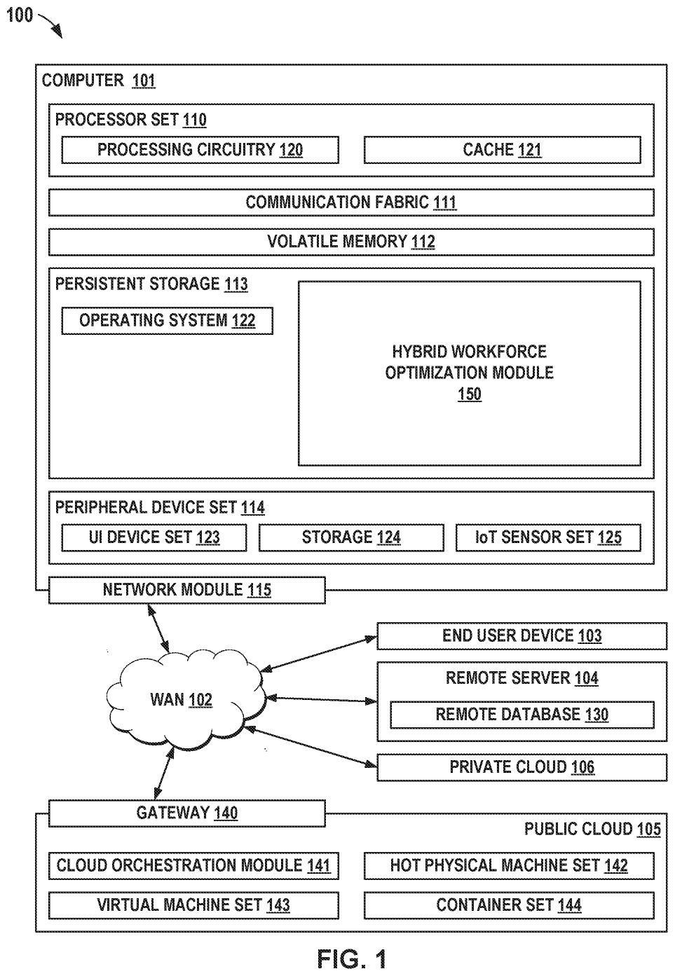

Referring to FIG. 1, computing environment 100 contains an example of an environment for the execution of at least some of the computer code involved in performing the inventive methods, such as hybrid workforce optimization module 150. In addition to hybrid workforce optimization module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and query response hybrid workforce optimization module 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in hybrid workforce optimization module 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in hybrid workforce optimization module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Computer environment 100 may be used to optimize a hybrid workforce to complete tasks in an industrial environment. In particular, the hybrid workforce optimization module 150 may identify tasks to be completed by a hybrid workforce, consisting of both human and robotic workers, in an environment. Tasks may be assigned to an environment and workforce in the form of a request or, alternatively, video or audio may be obtained from the environment and tasks may be identified in the video or audio. The hybrid workforce optimization module 150 may obtain a profile for each worker, both human and robotic, in the hybrid workforce to determine the capability of each worker in the profile to complete the task. An understanding of the capability of each member of the hybrid workforce may allow the hybrid workforce optimization module 150 to associate each task with an appropriate worker, both determining whether the task is best suited for a human or robotic worker and then determining a specific worker to complete the task. Based on this association, the hybrid workforce optimization module 150 may display an assignment of the task to be completed by the hybrid workforce on a device associated with the environment that may include a classification of the task and an association with the hybrid workforce and transmit instructions to an associated worker for completing the task, for instance in the form of instructions to a robot or a notification to a device associated with a human worker.

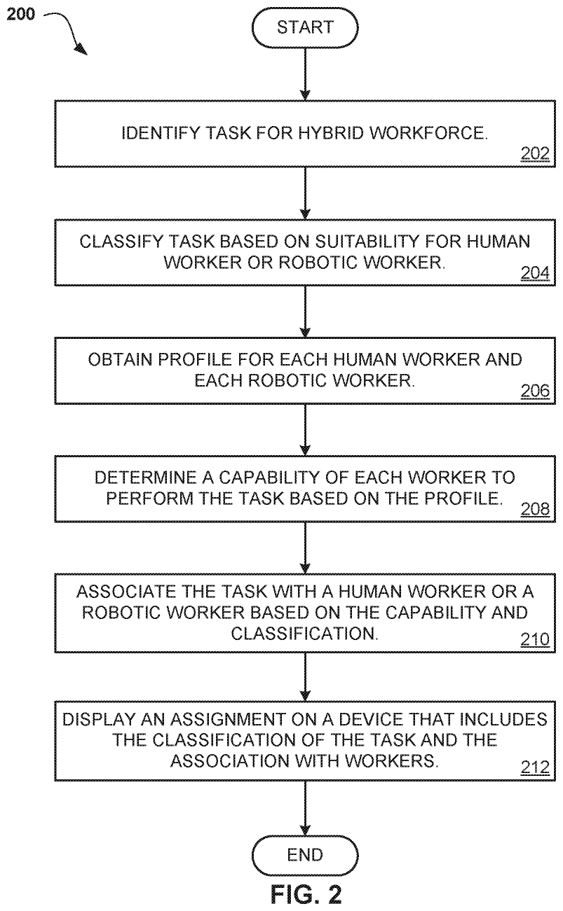

Referring to FIG. 2, an operational flowchart illustrating a process 200 that optimizes a hybrid workforce to complete tasks in an environment is depicted according to at least one embodiment. At 202, a task for the hybrid workforce may be identified. A group of activities leading to an end result may be identified at this step, e.g., making a specific product on a factory floor, but in that case, the identification process would include breaking the task into the individual activities that make up the task. As a result, an identified task represents a specific activity such as lifting a box or driving a vehicle, etc. Also, tasks may be submitted to the environment or hybrid workforce as a request, such as a management directive or scheduled event, or else video and audio of an environment may be captured using an appropriate device and techniques such as computer vision or object recognition may be used to understand activities currently taking place that may require analysis, including work being performed by human workers or robotic workers.

In the case of video or audio capture of human activity, it should be noted that all collection of information from a user or any video, audio or text that may personally identify a human user or is sensitive in any other way requires the informed consent of all people whose information may be collected and analyzed by hybrid workforce optimization module 150. Consent may be obtained in real time or through a prior waiver or other process that informs a subject that their information may be captured by a device or other process and that the information may be used to identify current tasks in an environment or as explained below, determine a capability of the human worker to complete identified tasks in the environment. The information owner is free to decide at any time to revoke consent for use of sensitive information as these settings are permanently retained to keep the hybrid workforce optimization module 150 updated with the latest information and also allow the owner of the information complete control over their informed consent to use sensitive information in the process described herein. The consent described here may also refer to allowing some, or any, data relating to the information owner from being sent to a local server, cloud server or any other location. The owner has complete control on the transmission of information that may be sensitive or personally identify the owner of the information.

At 204, tasks may be classified based on whether they are suitable for completion by a human worker or a robotic worker. Such classification may be made based on an understanding of both the tasks and tendencies of both human workers and robotic workers, including the types of skills required to complete a task or activity, e.g., an object may be too heavy to reasonably assign the task to a human worker or may require assistance such as a forklift to complete the task or activity, or perhaps a time when the activity is to be performed, for instance if something must be done during overnight hours, then it may be better to assign a robotic worker to the task. One of ordinary skill in the art will recognize that this list of factors is not exhaustive. It should be noted that specific workers to perform the task or activity may not be identified at this stage, but rather simply whether the task is better suited to a human or a robot for completion.

In an embodiment, a supervised machine learning model may be trained to predict whether an identified task should be assigned to, or associated with, a human worker or a robotic worker and then classify identified tasks using the prediction results. One or more of the following machine learning algorithms may be used: logistic regression, naive Bayes, support vector machines, deep neural networks, random forest, decision tree, gradient-boosted tree, multilayer perceptron. In an embodiment, an ensemble machine learning technique may be employed that uses multiple machine learning algorithms together to assure better classification when compared with the classification of a single machine learning algorithm. In this embodiment, training data for the model may include any prior instances of robots or humans completing various tasks either in the environment or in any location for which data exists. The training data may take the form of video or audio of users completing tasks or activities or interacting with each other or may be obtained within user profiles. In the case of robots, there may exist detailed information about the capabilities of a robot that may be used to determine if the task should be performed by a robotic worker. In addition, schedule data related to available shifts on a production floor or other environment may also be used as training data for the model. The training data may be collected from a single instance of a human or robot completing a specific task or by monitoring humans and robots as a group, either together as the hybrid workforce or in any context that may be relevant to understand how the monitored worker may complete various tasks or activities. The prediction results may be stored in a database so that the data is most current, and the output would always be up to date.

At 206, a profile may be obtained for each human worker and each robotic worker in the hybrid workforce. The profile may take the form of employment records or other data that may have been uploaded, with the same disclaimer as mentioned above regarding data privacy. The profile at this step may include specific observations or recognized behaviors that may have been captured through monitoring in the environment over time, including information about how a specific human performs a task such as whether the human worker is capable of lifting heavy objects or other specific traits and characteristics in how the worker may perform the job. In addition, an understanding of the worker's schedule may be obtained at this step, such that the system or method may understand which workers are in the environment, whether they are at the beginning, middle or end of a work shift, and whether the time of day is such that an ability to complete an associated task may or may not be impaired. In the case of robotic workers, a profile may include the standard data mentioned above that describes general specifications or characteristics, but more information about specific conditions may be obtained here. For instance, a battery level may be appropriate or an awareness of whether or not maintenance may be under way could be relevant in understanding if the robotic worker is capable of performing a task at a specific time and place. There may be many characteristics obtained for each worker in the hybrid workforce with respect to an identified task or activity.

At 208, a capability to perform a specific activity may be determined for each human worker and each robotic worker from the profile information. This capability may be in the form of a score, where a higher score may indicate that a specific worker is more capable of performing the task. In an embodiment, a supervised machine learning model may be trained to understand the capability of specific workers, including generating the described score. Such a model may be the same model as the machine learning model that may predict or classify the identified tasks oy may be a separate machine learning model, where the training data for the model may similarly be the same or different as what may be used to predict task classification. As with the prior model, the results of the capability calculations may be stored in a database so that the data is most current, and the output would always be up to date.

In an embodiment, determining the capability of at least the robotic workers may be accomplished through a digital twin simulation of the robot that may achieve maximum precision in the determination of capability and also to capture multiple datapoints, including identifying the current effectiveness level of the robotic systems to perform different activities and the skills required to perform different steps to complete any activity. A digital twin is a virtual model designed to accurately reflect a physical object. The object being studied, e.g., a robotic worker, may be outfitted with various sensors related to vital areas of functionality which produce data about different aspects of the physical object's performance, such as battery level or other engine performance metrics. This data may then be relayed to a processing system and applied to the digital copy. Once informed with such data, the virtual model can be used to run simulations, study performance issues and generate possible improvements, all with the goal of generating valuable insights, all of which may then be applied back to the original physical object.

Although simulations and digital twins both utilize digital models to replicate various processes, a digital twin is actually a virtual environment and while a simulation typically studies one particular process, a digital twin can itself run any number of useful simulations in order to study multiple processes. Digital twins are designed around a two-way flow of information that first occurs when object sensors provide relevant data to the system processor and then happens again when insights created by the processor are shared back with the original source object. By having better and constantly updated data related to a wide range of areas, along with the added computing power that accompanies a virtual environment, digital twins are able to study more issues from far more vantage points than standard simulations and have greater ultimate potential to improve products and processes. Examples of the types of digital twins include component twins, which are the basic unit of digital twin or the smallest example of a functioning component, parts twins, which pertain to components of slightly less importance, asset twins, which study the interaction between components that work together, system (or unit) twins, which enable you to see how different assets come together to form an entire functioning system, and process twins, which are the macro level of magnification and reveal how systems work together to create an entire production facility, which may help determine the precise timing schemes that ultimately influence overall effectiveness.

While digital twin simulations may be used to make the robotic worker more efficient, in the context of the process 200, more data may be entered into the simulation to specifically understand the tasks that a robotic worker may perform, including scheduling data that may include maintenance windows or a number of robotic workers available at any one time. Also, while the digital twin may primarily be used for the robotic workers, a digital twin may also be created for the human workers, where anonymized, or “stick figure”, data may be taken from the profile data, and also any video/audio that may be obtained to classify an identified task, may be digitized and displayed as a digital twin that may be processed in the same way as the simulations described above. Digital twin simulations may also be created and used at this step that show the interaction between human workers and robotic workers and discover the best way to deploy a combination of workers in the hybrid workforce to complete an identified task.

At 210, each identified task may be associated with a specific member of the hybrid workforce, which may be a human worker or a robotic worker, based on the classification of the identified task and the capability determination in 208. This association may be simply choosing a highest capability score within the group of workers for which the identified task has been classified. As an example, a task may be classified as suitable for a human worker and a specific worker may be determined to be the most capable or have the highest score, in which case the identified task would be associated with the specific worker. It should be noted that an identified task may be assigned to a single specific worker, or if the task is so identified, multiple workers, including both human workers and robotic workers, may be assigned to a single identified task.

In an embodiment, a supervised machine learning model may also be trained to associate the identified task with a worker in the hybrid workforce, either human or robotic. One or more of the following machine learning algorithms may be used: logistic regression, naive Bayes, support vector machines, deep neural networks, random forest, decision tree, gradient-boosted tree, multilayer perceptron. In an embodiment, an ensemble machine learning technique may be employed that uses multiple machine learning algorithms together to assure better classification when compared with the classification of a single machine learning algorithm. In this embodiment, as with the classification model, training data for the model may include many factors to be considered in associating a task with a specific worker (or workers), including the results of a cost/benefit analysis, where the effort required to train a human worker as opposed to programming a robotic worker may be considered, along with other costs in the performance of tasks in the environment, and the specific worker may be identified and recommended. This type of analysis may be done using simulation of multiple combinations to identify the most effective combination of human and robotic workers to maintain the productivity of the hybrid workforce. Other training data may include an understanding of an end goal within the environment, where it may be the most efficient decision to associate a certain task with a specific worker with the sequencing of tasks in mind. For instance, it may not be the best decision to alternate between human workers and robotic workers for consecutive tasks and one or the other group may be assigned to individual tasks to keep the workflow stable in the environment. The training data may be collected from a single instance of a human or robot completing a specific task or by monitoring humans and robots as a group, either together as the hybrid workforce or in any context that may be relevant to understand how the monitored worker may complete various tasks or activities, as with the classification model. The association results may be stored in a database so that the data is most current, and the output would always be up to date. It should be noted that while the machine learning model mentioned in process 200 may be separate calculations and determinations for individual steps of process 200, the calculations and determinations may be performed by a single entity or group of entities. In other words, it is only required that separate calculations and determinations are reached, not that separate machine learning models be created.

Included at this step may be a feedback mechanism, whereby the results of the association of a task with a specific worker is recorded and used to refine the machine learning model. An understanding of the context of results may assist the model in making more informed decisions, which may enrich the knowledge corpus over time and iteratively produce higher quality results for repetitive tasking and work assignments overall. The richer the knowledge corpus, the greater the quality of assignment for both present and future tasking. Also included at this step is the ability of management of the hybrid workforce to make manual decisions about the association of identified tasks with members of the hybrid workforce and override decisions as needed, the results of which would also be included as feedback to the machine learning model. The interaction of such users with the assignment would be monitored and updates to the assignment, including changes to the classification of the identified task and the association of the task to a human worker or robotic worker (or both), may be made based on the user interactions.

At 212, an assignment of the identified task, which includes the classification of the identified task and the association of the task with a human or robot, may be displayed on a device such as a monitor in the environment or a mobile device connected to the hybrid workforce. At the step, one or more workers in the hybrid workforce with whom an identified task has been associated may also be notified of the association and sent further instructions. In the case of a robotic worker, a set of instructions or detailed programming may be transmitted so that the robot may begin work. In the case of a human worker, a notification may be transmitted to a device such that the human worker may be aware of the association and also receive further instructions as necessary to work toward completion of the identified task. The device that may receive the notification may be already associated with the human worker, such as a smartphone or other mobile device, or may be a device that is common to the environment, such as a monitor that may be mounted in the environment and that the human worker can sec. In addition, notifications are not limited to a human worker with which an identified task may be associated. Management or another authority that may be responsible for the output of the hybrid workforce may also receive notifications and the transmitted information may include any of the digital twin simulations mentioned above or any information that may inform management about the decision to associate identified tasks with specific workers.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimizing a hybrid workforce to complete tasks in an environment, the method comprising:
identifying a task to be completed by the hybrid workforce in the environment, wherein the hybrid workforce includes a plurality of human workers and a plurality of robotic workers;
classifying the task based on whether the task is suitable for being completed by a human or by a robot;
obtaining a profile for each human worker in the plurality of human workers and for each robotic worker in the plurality of robotic workers;
determining a capability to perform the task to be completed by the hybrid workforce for each human worker and for each robotic worker from the profile;
associating the task with a robotic worker in the plurality of robotic workers, wherein the robotic worker has a highest capability when the task is suitable for being completed by the robot; and
displaying an assignment of the task to be completed by the hybrid workforce on a device associated with the environment, wherein the assignment includes a classification of the task and an association with the hybrid workforce.

2. The computer-implemented method of claim 1, further comprising transmitting an instruction set to the robotic worker associated with the task to be completed by the hybrid workforce.

3. The computer-implemented method of claim 1, further comprising:
associating the task with a human worker in the plurality of human workers, wherein the human worker has the highest capability when the task is suitable for being completed by the human; and
transmitting a notification to a second device associated with the human worker.

4. The computer-implemented method of claim 1, further comprising:
capturing task data from the environment, wherein the task data is selected from a group consisting of video data and audio data; and
identifying the task to be completed by the hybrid workforce in the task data.

5. The computer-implemented method of claim 1, further comprising:
creating a digital twin instance for each robot worker in the plurality of robot workers and for each human worker in the plurality of human workers;
simulating the task using the digital twin instance; and
updating the capability to perform the task to be completed by the hybrid workforce based on a digital twin simulation output.

6. The computer-implemented method of claim 1, further comprising:
monitoring user interactions with the assignment of the task to be completed by the hybrid workforce; and
updating the classification of the task and the association with the hybrid workforce based on the user interactions.

7. The computer-implemented method of claim 1, wherein a machine learning model that predicts suitability of a worker to a specific task from profile information about the worker is used to classify an identified task.

8. A computer system for optimizing a hybrid workforce to complete tasks in an environment, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying a task to be completed by the hybrid workforce in the environment, wherein the hybrid workforce includes a plurality of human workers and a plurality of robotic workers;
classifying the task based on whether the task is suitable for being completed by a human or by a robot;
obtaining a profile for each human worker in the plurality of human workers and for each robotic worker in the plurality of robotic workers;
determining a capability to perform the task to be completed by the hybrid workforce for each human worker and for each robotic worker from the profile;
associating the task with a robotic worker in the plurality of robotic workers, wherein the robotic worker has a highest capability when the task is suitable for being completed by the robot; and
displaying an assignment of the task to be completed by the hybrid workforce on a device associated with the environment, wherein the assignment includes a classification of the task and an association with the hybrid workforce.

9. The computer system of claim 8, further comprising transmitting an instruction set to the robotic worker associated with the task to be completed by the hybrid workforce.

10. The computer system of claim 8, further comprising:
associating the task with a human worker in the plurality of human workers, wherein the human worker has the highest capability when the task is suitable for being completed by the human; and
transmitting a notification to a second device associated with the human worker.

11. The computer system of claim 8, further comprising:
capturing task data from the environment, wherein the task data is selected from a group consisting of video data and audio data; and
identifying the task to be completed by the hybrid workforce in the task data.

12. The computer system of claim 8, further comprising:
creating a digital twin instance for each robotic worker in the plurality of robotic workers and for each human worker in the plurality of human workers;
simulating the task using the digital twin instance; and
updating the capability to perform the task to be completed by the hybrid workforce based on a digital twin simulation output.

13. The computer system of claim 8, further comprising:
monitoring user interactions with the assignment of the task to be completed by the hybrid workforce; and
updating the classification of the task and the association with the hybrid workforce based on the user interactions.

14. The computer system of claim 8, wherein a machine learning model that predicts suitability of a worker to a specific task from profile information about the worker is used to classify an identified task.

15. A computer program product for optimizing a hybrid workforce to complete tasks in an environment, the computer program product comprising:
a computer-readable storage medium having program instructions embodied therewith, the program instructions executable by a processor to cause the processor to perform a method comprising:
identifying a task to be completed by the hybrid workforce in the environment, wherein the hybrid workforce includes a plurality of human workers and a plurality of robotic workers;
classifying the task based on whether the task is suitable for being completed by a human or by a robot;
obtaining a profile for each human worker in the plurality of human workers and for each robotic worker in the plurality of robotic workers;
determining a capability to perform the task to be completed by the hybrid workforce for each human worker and for each robotic worker from the profile;
associating the task with a robotic worker in the plurality of robotic workers, wherein the robotic worker has a highest capability when the task is suitable for being completed by the robot; and
displaying an assignment of the task to be completed by the hybrid workforce on a device associated with the environment, wherein the assignment includes a classification of the task and an association with the hybrid workforce.

16. The computer program product of claim 15, further comprising transmitting an instruction set to the robotic worker associated with the task to be completed by the hybrid workforce.

17. The computer program product of claim 15, further comprising:
associating the task with a human worker in the plurality of human workers, wherein the human worker has the highest capability when the task is suitable for being completed by a human; and
transmitting a notification to a second device associated with the human worker.

18. The computer program product of claim 15, further comprising:
capturing task data from the environment, wherein the task data is selected from a group consisting of video data and audio data; and
identifying the task to be completed by the hybrid workforce in the task data.

19. The computer program product of claim 15, further comprising:
creating a digital twin instance for each robotic worker in the plurality of robotic workers and for each human worker in the plurality of human workers;
simulating the task using the digital twin instance; and
updating the capability to perform the task to be completed by the hybrid workforce based on a digital twin simulation output.

20. The computer program product of claim 15, further comprising:
monitoring user interactions with the assignment of the task to be completed by the hybrid workforce; and
updating the classification of the task and the association with the hybrid workforce based on the user interactions.
